(19) United States
(12) Patent Application Publication
(10) Pub. No.: US 2026/0080380 A1
(43) Pub. Date: Mar. 19, 2026

(54) SYSTEMS, DEVICES, AND METHODS FOR THE DISTRIBUTION OF SHARED DIGITAL FUNDS

(71) Applicant: VeriFone, Inc., Wilmington, DE (US)

(72) Inventor: Nicholas Kenneth John Tristram, Hillingdon (GB)

(73) Assignee: VeriFone, Inc., Wilmington, DE (US)

(21) Appl. No.: 19/110,906

(22) PCT Filed: Sep. 12, 2022
(86) PCT No.: PCT/US2022/076263

§ 371 Date: Mar. 12, 2025

(51) Int. Cl. G06Q 20/10; G06Q 20/34; G06Q 20/40

(52) U.S. Cl. CPC G06Q 20/10; G06Q 20/352; G06Q 20/4014

(57) ABSTRACT

Systems, devices, and methods of distributing shared digital funds are provided herein. The systems, devices, and methods enable the distribution of shared digital funds to multiple digital fund participants and/or mobile device users via contactless payment instruments. Each user and/or participant may have simultaneous, real-time access to a digital fund managed in a digital fund database stored in a remote server or a collection of remote servers. Further, each user and/or participant of a group may initiate one or more transactions on behalf of the group using one or more contactless payment instruments connected with one or more digital funds.

### FIELD OF THE DISCLOSURE

The present disclosure is directed generally to systems, devices, and methods for the distribution and maintenance of shared digital funds.

### BACKGROUND

A shared pool of money (sometimes referred to as a “kitty” or more generally as a communal collection of funds) is usually formed by a group of individuals defining a budget for a particular purpose. Traditionally, each member of the group contributes an amount of physical cash into the shared pool, which is collected and held by a single individual. The holder of the pooled money will then make purchases using the physical money on behalf of the group. At some point in time, typically when the shared pool of money no longer serves the intended purpose, the remaining pooled money may be divided back up among the group members.

While this traditional approach is simple and does not require any particular electronic devices, it has several drawbacks. For example, the holder of the pooled funds typically has to perform the purchasing and has the responsibility for the accounting, only the holder knows the true balance of the shared pool of money, mathematical errors are not easily reviewed or resolved, some group members may not have the required amount to contribute into the pool of money, and dividing up the balance at the end of the time period can often be difficult (requiring exact change), forgotten, and/or done incorrectly. In addition to these challenges and lack of transparency, many places of business are moving to cashless systems.

### SUMMARY OF THE DISCLOSURE

The present disclosure is directed to systems, devices, and methods of distributing shared digital funds. More specifically, the present disclosure is directed to systems, devices, and methods of distributing shared digital funds to multiple digital fund participants or mobile device users via contactless payment instruments.

According to an example of the present disclosure, a system supporting a payment network of digital funds is provided. The system comprises a digital fund database comprising: a plurality of participant accounts, each participant account being associated with at least one user and comprising a digital payment source; and a digital fund, the digital fund being connected to each of the plurality of participant accounts and being accessible via a contactless payment instrument. The system further comprises a remote server in communication with one or more payment processors and a plurality of mobile devices, each of the plurality of mobile devices being associated with one of the plurality of participant accounts and the respective at least one user, wherein the remote server comprises or is in communication with the digital fund database and is configured to: receive a request from at least one of the plurality of mobile devices via a digital fund application being executed on the plurality of mobile devices, the request comprising a request to create and/or fund the digital fund by the plurality of participant accounts; process, for each of the plurality of participant accounts via the one or more payment processors, a transaction adding a currency amount to the digital fund from the one or more digital payment sources to create a funded digital fund, wherein each of the plurality of participant accounts contributes an equal currency amount to the digital fund; generate, via the one or more payment processors, a contactless payment instrument connected with the funded digital fund, each contactless payment instrument comprising payment information, wherein each of the plurality of participant accounts are enabled to access the contactless payment instrument; and update each of the plurality of participant accounts with the payment information for the contactless payment instrument.

In an aspect, the remote server is further configured to receive, from one or more payment processors, transaction information for a transaction instance corresponding to a transaction using the contactless payment instrument.

In an aspect, the digital fund database further comprises a digital ledger comprising a record of each transaction instance associated with the digital fund, and wherein the remote server is configured to update the digital ledger upon receiving the transaction information.

In an aspect, the funded digital fund comprises a predetermined time limit, wherein upon reaching the predetermined time limit the remote server suspends the contactless payment instrument and refunds, using the one or more payment processors, any currency amount remaining in the funded digital fund split evenly to the plurality of participant accounts.

In an aspect, wherein upon receiving a closing request from any one of the plurality of participants, the remote server suspends the contactless payment instrument and refunds, using the one or more payment processors, any currency amount remaining in the funded digital fund split evenly to the plurality of participant accounts.

In an aspect, the remote server is configured to generate the contactless payment instrument connected with the digital fund upon receiving a request from one of the plurality of mobile devices.

In an aspect, the one or more digital payment sources includes at least one of: a bank account, a credit card, a debit card, an online payment account, and a digital wallet.

In an aspect, the remote server is further configured to: receive, from one of the plurality of mobile devices, user information comprising user credentials, wherein the user information corresponds to the participant account associated with the mobile device; validate the received user credentials in connection with the participant account from the digital fund database; upon validation of the user credentials, transmit participant account information to the mobile device.

According to another example of the present disclosure, a mobile device associated with a digital payment network is provided. The mobile device includes a processor and a digital fund application configured to cause the mobile device to: (i) transmit a request to create and/or fund a digital fund of the digital payment network by a plurality of participant accounts including the participant account associated with the mobile device, the digital fund being connected to each of the plurality of participant accounts and being accessible via a contactless payment instrument; (ii) receive information from the digital payment network comprising confirmation that the digital fund has been funded by the plurality of participant accounts, wherein each of the plurality of participant accounts funds an equal portion of the digital fund, and wherein the received information further comprises a contactless payment instrument connected with the funded digital fund, the contactless payment instrument comprising payment information, wherein each of the plurality of participant accounts are enabled to access the contactless payment instrument; and (iii) make a transaction using the contactless payment instrument.

In an aspect, the digital fund comprises a predetermined time limit, wherein upon reaching the predetermined time limit the contactless payment instrument is suspended, and wherein the processor and the digital fund application are further configured to cause the mobile device to: receive information from the digital payment network comprising a refund, split evenly amount the plurality of participant accounts, of any currency amount remaining in the funded digital fund upon reaching the predetermined time limit.

In an aspect, the processor and the digital fund application are further configured to cause the mobile device to: transmit a closing request to the digital payment network; and receive information from the digital payment network comprising a refund, split evenly amount the plurality of participant accounts, of any currency amount remaining in the funded digital fund upon receiving the closing request.

In an aspect, the processor and the digital fund application are further configured to cause the mobile device to: transmit user information comprising user credentials to the digital payment network, wherein the user information corresponds to the participant account associated with the mobile device; and receive participant account information from the digital payment network once the transmitted user credentials are validated.

In an aspect, the processor and the digital fund application are further configured to cause the mobile device to: receive, from the digital payment network, one or more of transaction information for one or more transaction instances associated with the digital fund, and a real-time balance amount of the digital fund.

In an aspect, the processor and the digital fund application are further configured to cause the mobile device to: display, on a display screen, one or more of information about the digital fund, and payment information or transaction information corresponding to the contactless payment instrument.

In an aspect, the digital fund comprises a digital fund restriction, the digital fund restriction comprising one or more of a location-based restriction, a merchant-based restriction, and a time-based restriction.

In an aspect, the processor and the digital fund application are further configured to cause the mobile device to: transmit payment information of the contactless payment instruments to a payment terminal, wherein transmitting the payment information to the payment terminal initiates a transaction instance.

According to still another example of the present disclosure, a method of generating a contactless payment instrument funded by a digital fund of a digital payment network is provided. The method includes: (i) receiving, from a mobile device executing a digital fund application, a request to fund a digital fund of the digital payment network, wherein the digital fund is funded by a plurality of participant accounts including a participant account associated with the mobile device, the digital fund being connected to each of the plurality of participant accounts; (ii) processing, for each of the plurality of participant accounts via one or more payment processors, a transaction adding a currency amount to the digital fund, wherein each of the plurality of participant accounts contributes an equal currency amount to the digital fund; (iii) generating, via the one or more payment processors, a contactless payment instrument connected with the digital fund, each contactless payment instrument comprising payment information, wherein each of the plurality of participant accounts are enabled to access the contactless payment instrument; and (iv) updating each of the plurality of participant accounts with the payment information for the contactless payment instrument.

In an aspect, the digital fund comprises a predetermined time limit, and the method further comprises: suspending or terminating the contactless payment instrument when the predetermined time limit is reached; and refunding, using the one or more payment processors, any currency amount remaining in the digital fund split evenly among the plurality of participant accounts.

In an aspect, the method further comprises: receiving a closing request from any one of the plurality of participants; suspending or terminating the contactless payment instrument in response to the received closing request; and refunding, using the one or more payment processors in response to the received closing request, any currency amount remaining in the digital fund split evenly among the plurality of participant accounts.

In an aspect, the method further comprises: receiving, from a mobile device associated with one of the plurality of participant accounts, transaction information for a transaction instance corresponding to a transaction using the contactless payment instrument.

These and other aspects of the various embodiments will be apparent from and elucidated with reference to the embodiment(s) described hereinafter.

### BRIEF DESCRIPTION OF THE DRAWINGS

FIG. 1 is a diagram illustrating a system for distributing shared digital funds to a group of individuals according to aspects of the present disclosure.

FIG. 2 is a diagram illustrating the relationship between multiple users and different shared digital funds according to aspects of the present disclosure.

FIG. 3 is a diagram illustrating the initial deployment and setup of digital fund application according to aspects of the present disclosure.

FIG. 4 is a flow diagram illustrating the generation of a shared digital fund according to aspects of the present disclosure.

FIG. 5 is a flow diagram illustrating the use of a shared digital fund according to aspects of the present disclosure.

FIG. 6 is a schematic diagram illustrating a mobile device according to aspects of the present disclosure.

FIG. 7 is a flow diagram illustrating the de-activation of a shared digital fund according to aspects of the present disclosure.

FIG. 8 illustrates a flowchart of a method of distributing one or more contactless payment instruments according to certain aspects of the present disclosure.

### DETAILED DESCRIPTION

The present disclosure is directed to systems, devices, and methods of distributing shared digital funds. More specifically, the present disclosure is directed to systems, devices, and methods of distributing shared digital funds to multiple digital fund participants or mobile device users via contactless payment instruments. According to examples of the present disclosure, each user and/or participant may have simultaneous, real-time access to a digital fund managed in a digital fund database stored in a remote server or a collection of remote servers. Further, according to examples of the present disclosure, each user and/or participant of a group may initiate one or more transactions on behalf of the group using one or more contactless payment instruments connected with one or more digital funds. According to examples of the present disclosure, these transactions may be recorded in the digital fund database and made available for viewing in real-time by other participants or users associated with the corresponding one or more digital funds.

According to an embodiment, the systems, devices, and methods of creating and utilizing shared digital funds disclosed herein provides numerous advantages over the prior art. For example, the digital payment system or network facilitates quick and easy funding of a digital fund by a group of users, equally, and just as quickly and easily creates the contactless payment instrument that each of the users can access and utilize (although it is also possible that the system can comprise a single or limited number of designated payors that can access and utilize the contactless payment instrument). The digital payment system or network allows all users to see the balance, in real-time, of the one or more digital funds they are members of or have contributed to. The digital payment system or network also allows for utilization restrictions that enables a level of customization not previously available. For example, the utilization restrictions can be a location-based restriction such as a geofence among other options. The utilization restrictions can be a merchant-based restriction where the contactless payment instrument can only be utilized at certain predetermined merchants, or types of merchants. The utilization restrictions can be a time-based restriction where the contactless payment instrument can only be utilized before expiration of a certain predetermined time period or limit. Additionally, as a function of a time-based restriction, or as another option unrelated to restrictions, the digital payment system or network allows for the funds within a digital fund to be refunded equally among the funding members at the end of a predetermined time period or limit.

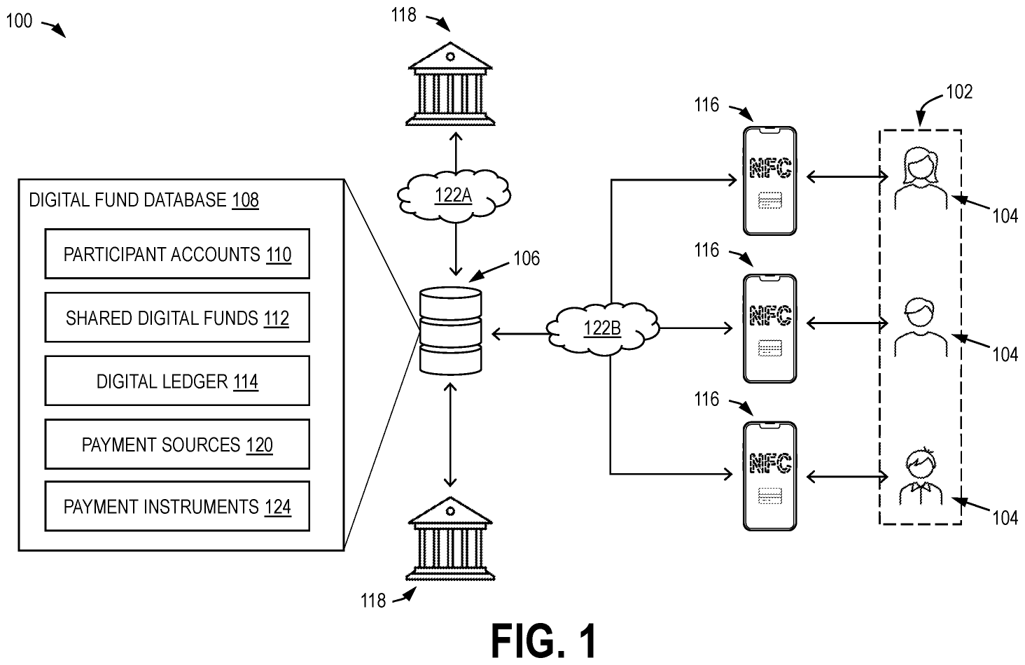

FIG. 1 illustrates a system 100 for the distribution of a shared digital fund to a group 102 of individuals 104. As shown, the system 100 may include a remote server 106 supporting a digital fund database 108 configured to store, manage, and/or otherwise maintain a plurality of participant accounts 110, a plurality of shared digital funds 112, a digital ledger 114 comprising a record of a plurality of transaction instances associated with one or more participant accounts 110, and/or one or more contactless payment instruments 124.

In the example of FIG. 1, each individual 104 may be a user of a mobile device 116 that is configured to execute a digital fund application that enables access to the remote server 106 and the digital fund database 108. Each individual 104 may use a different mobile device 116 that is in communication with the remote server 106 to establish a participant account 110 within the digital fund database 108. Using the digital fund application, each user 104 may also create one or more shared digital funds 112 that become accessible to each participant account 110 connected with the shared digital fund 112 via a contactless payment instrument 124 generated by the remote server 106. As used herein, the terms “digital fund” and “shared digital fund” are used interchangeably to refer to a collection or pool of money accessible digitally. Further, as used herein, the term “contactless payment instrument” is used to refer to a digital financial/payment instrument that can be used to complete financial transactions between two entities.

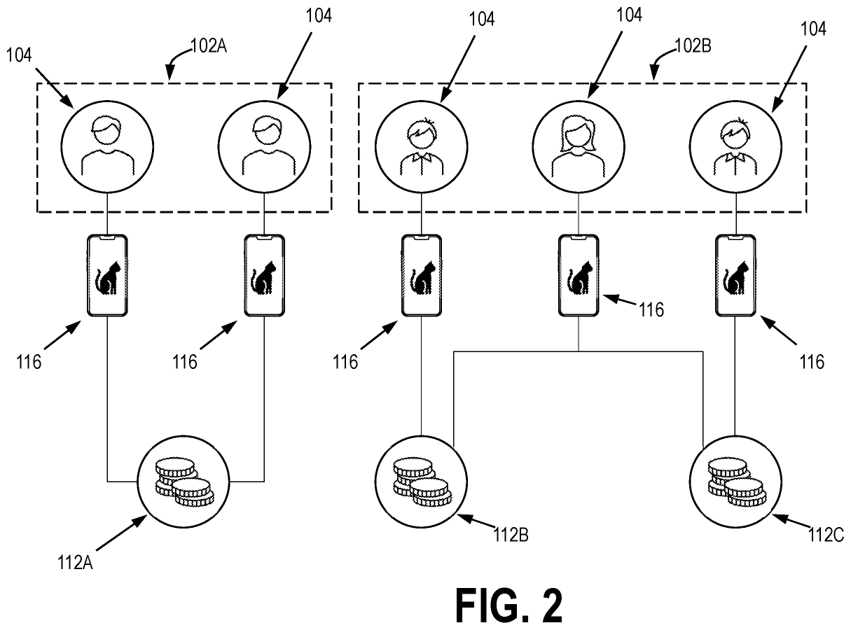

In certain examples, one or more digital funds 112 may be connected to at least one participant account 110, each participant account 110 being associated with at least one user 104. In the example of FIG. 2, a first group 102A of individual users 104 may each have their own participant accounts 110 that may be accessible via one or more mobile devices 116 and may be connected to at least one digital fund 112A. Similarly, a second group 102B of individual users 104 may each have their own participant accounts 110 that may be accessible via one or more mobile devices 116 and may be connected to at least one digital fund 112B, 112C. In the example of FIG. 2, the second group 102B of individual users 104 comprises one user 104 having access to multiple shared digital funds 112B, 112C, while two other users 104 only have access to one of the shared digital funds 112B, 112C. It should be appreciated that the number of individual users 104 (i.e., the size of a group 102) may be as small as one or two individual users 104 or may include over 100 users 104. Further, it should be appreciated that each user 104 may be connected with one or more digital funds 112 through their participant account(s) 110.

According to examples of the present disclosure, the remote server 106 may be in communication with one or more payment processors 118 to perform and/or otherwise record one or more transaction instances associated with the one or more digital funds 112. As used herein, the term “payment processor” 118 is intended to be a third-party entity that receives payment information from the user 104 and performs or handles the financial transaction between a source of funds and the destination of the funds.

For instance, in the example of FIG. 1, the one or more users 104 may provide one or more digital payment sources 120 using the one or more mobile devices 116 (e.g., via the digital fund application), which may be used to fund one or more shared digital funds 112. More specifically, the remote server 106 may process, via the one or more payment processors 118, one or more financial transactions that add an amount of currency/money to one or more of the digital funds 112. The one or more digital payment sources 120 may include, but are not limited to, a bank account, a credit card, a debit card, a PAYPAL® account, a GOOGLE PAY® account, a BIZUM® account, a PAYM® account, any online or digital payment method, and/or a digital wallet. In some examples, a user 104 may use their mobile device 116 and their participant account 110 (i.e., via the digital fund application) to request that the remote server 106 process, via the one or more payment processors 118, at least one financial transaction that adds an amount of currency/money to one or more of the digital funds 112 connected with that user's 104 participant account 110.

Additionally, in the example of FIG. 1, the remote server 106 may be in direct communication with one or more payment processors 118 and/or may communicate with one or more payment processors 118 over a communication network 122A. In some examples, the communication network 122A can include a number of wired and/or wireless connections, and may utilized a variety of information transfer protocols and/or security features (e.g., encryption, etc.). Similarly, the one or more mobile devices 116 may communicate with the remote server 106 via a communication network 122B, which can include a number of wired and/or wireless connections, and may utilized a variety of information transfer protocols and/or security features (e.g., encryption, etc.).

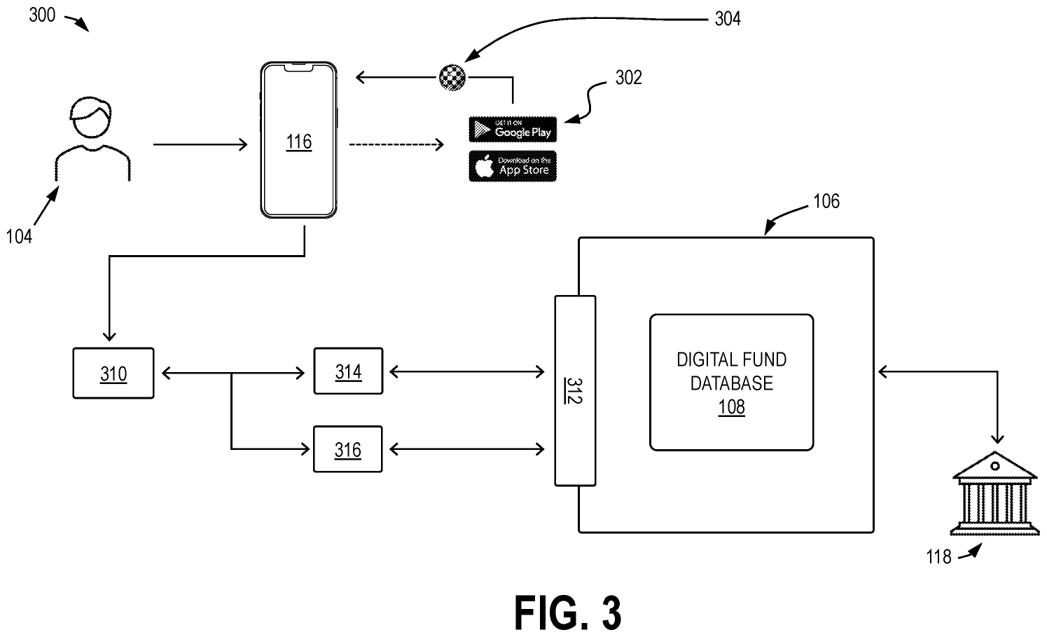

FIG. 3 illustrates an example of the registration and initialization process 300 for a single user 104 to establish a participant account 110 and a shared digital fund 112. As shown, a user 104 may use a mobile device 116 to access one or more program repositories (e.g., Google Play®, Apple's App Store®, etc.) in order to download and install a digital fund application 304 to the mobile device 116. Once downloaded and installed, the digital fund application 304 may be launched or executed on the mobile device 116. Put another way, an application instance 310 for the digital fund application 304 may be created using one or more processors of the mobile device 116.

Within the application instance 310 of the digital fund application 304, one or more requests may be transmitted from the mobile device 116 to a remote server 106. In some examples, the user 104 may not yet have a participant account 110 and therefore needs to first register with a web-based service 312 associated with the remote server 106. That is, a registration request 314 may be sent via the digital fund application instance 310 executed on the mobile device 116 of the user 104.

In some examples, the user 104 may provide user information with the registration request 314, including but not limited to, the user's 104 name, contact information, biographical information, authorized devices. In further examples, the user information may include a username, account identification, one or more digital payment methods, and/or credentials used to access the participant account 110 after registration. In particular examples, the mobile device 116 can include a user input device, which the user information may use to input the user information. For instance, the user input device may include, but is not limited to, a touch-enabled display screen, a keyboard, and the like.

In the example of FIG. 3, the user 104 may also make one or more other requests 316 using the application environment 310 of the digital fund application 304. In some examples, the one or more other requests 316 can include, but are not limited to, a request to open a new digital fund 112 in the digital fund database 108; a request to connect a new participant account 110 with one or more digital funds 112 in the digital fund database 110; a request to add a currency amount to one or more digital funds 112 in the digital fund database 108 from the one or more digital payment sources 120; and/or a request to de-activate one or more digital funds 112 in the digital fund database 108.

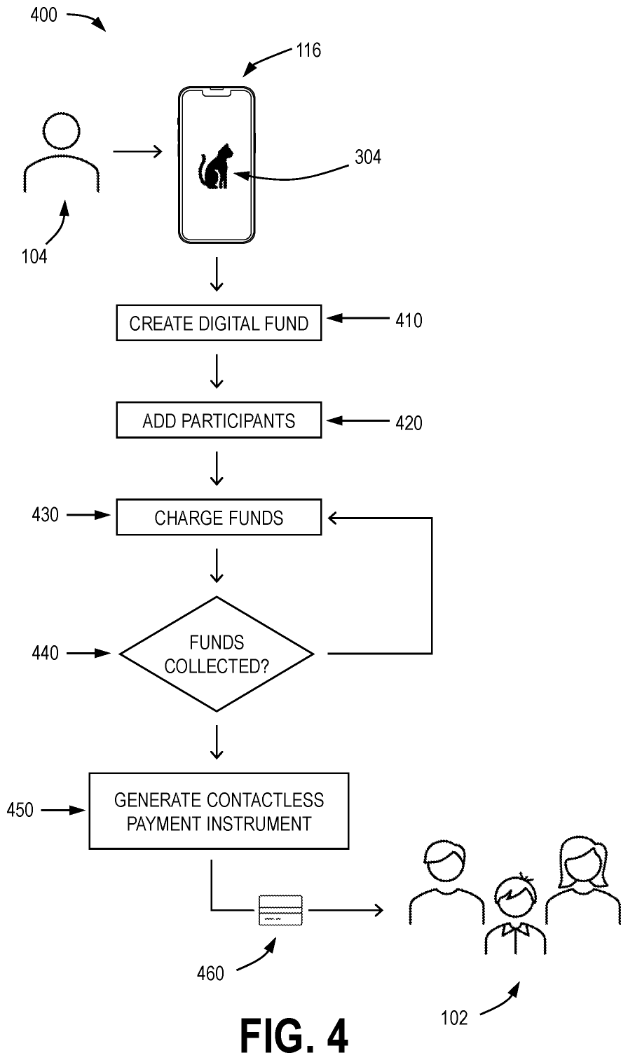

FIG. 4 illustrates an example of a method 400 for creating a shared digital fund 112 according to the present disclosure. In a step 410, using a mobile device 116 executing a digital fund application 304, the user 104 may send a request to create a new digital fund 112 to a remote server 106 supporting a digital fund database 108.

In a step 420, once a new digital fund 112 is created in the digital fund database 108 by the remote server 106, the user 104 may add one or more other participant accounts 110 to the newly created digital fund 112. That is, the user 104 may invite other individuals 104 to create participant accounts 110 and/or connect their existing participant accounts 110 with the newly created digital fund 112.

In a step 430, the one or more participant accounts 110 connected with the newly created digital fund 112 may be charged or otherwise contribute to the funding of the shared digital fund 112. In particular, the remote server 106 may utilize the one or more digital payment sources 120 associated with each of the one or more participant accounts 110 to add an amount of currency to the shared digital fund 112.

In a step 440, the remote server 106 may check to determine whether all of the required funds have been collected. If there are outstanding participant accounts 110 (e.g., participant accounts that have not yet contributed to the digital fund 112 or have not contributed a required amount), then the method 400 may wait until the required funds are changed in step 430.

Otherwise, if the required contributions have all been satisfied, then in a step 450, the remote server 106 may generate a contactless payment instrument 124. As mentioned above, the term “contactless payment instrument” is used to refer to a digital financial/payment instrument that can be used to complete financial transactions between two entities. In some examples, the contactless payment instrument 124 comprises payment information sufficient for one or more payment processors 118 to process a financial transaction using the contactless payment instrument 124. For instance, the payment information can include a 16-digit card number, an expiration date, a security code, and the like. In some embodiments, the payment information may be encoded and/or encrypted in manner that a payment terminal may read (e.g., a barcode, a QR code, etc.).

In some examples, the contactless payment instrument 124 may be a general-purpose reloadable prepaid card, a prepaid gift card, a retail prepaid card, a prepaid travel card, a prepaid cashback card, and/or the like. In further examples, the contactless payment instrument 124 is a digital payment instrument that is adapted to be used via the mobile device 116 of the user 104. For example, the contactless payment instrument 124 may be a digital payment instrument that is loadable into the user's 104 digital wallet (i.e., outside of the environment 310 of the digital fund application 304).

In a step 460, the contactless payment instrument 124 may be issued and/or otherwise shared with a group 102 of users 104 associated with the shared digital fund 112. In particular, the participant accounts 110 corresponding to each of the users 104 of the group 102 may be updated with the payment information corresponding to the contactless payment instrument 124. As such, each user 104 may then receive the contactless payment instrument 124 via the digital fund application 304 executed via the mobile device 116 of the user 104.

In some examples, the remote server 106 (accessible via the digital fund application 304 of the mobile device 116), may require the user 104 to be verified prior to acting upon any request and/or transmitting any information, including a request to create a new digital fund 112 or transmitting any contactless payment instruments 124. As such, in some examples, the remote server 106 may receive from the mobile device 116 user information comprising user credentials that correspond to at least one participant account 110 from the digital fund database 108. The remote server may then validate the user credentials in connection with the at least one participant account 110. Upon validation of the user credentials, the user request and/or account information may be completed and/or transmitted, as the case may be. For instance, in some examples, upon validation of the user credentials, the remote server 106 may transmit participant account information corresponding to at least one participant account 110 to the one or more mobile devices 116, wherein the participant account information comprises at least one of a contactless payment instrument 124 and/or a portion of the digital ledger 114 corresponding to the at least one participant account.

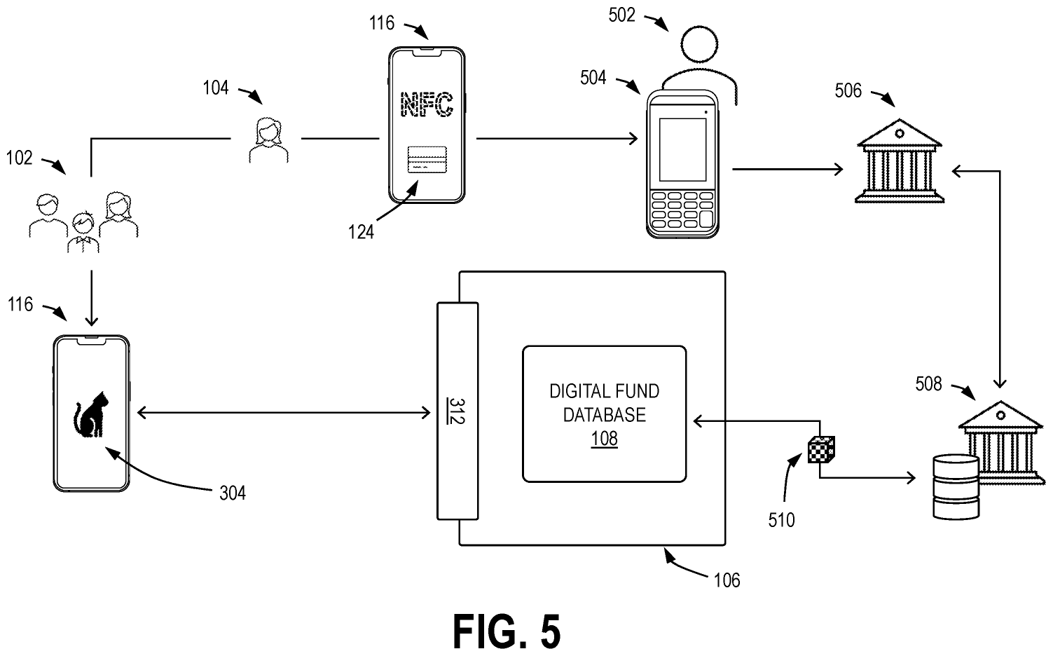

FIG. 5 illustrates a flow diagram showing the use of a mobile device 116 in connection with a system 100 for the distribution of a shared digital fund 112. As discussed herein, a group of individuals 104 may utilize one or more mobile devices 116 executing a digital fund application 304 in conjunction with a remote server 106 supporting a digital fund database 108 in order to establish one or more participant accounts 110 connected with a shared digital fund 112. Once the shared digital fund 112 is created and the participants 104 of the group 102 have funded the shared digital fund 112, a contactless payment instrument 124 can be generated by the remote server 106. Then, the contactless payment instrument 124 may be loaded into each participant account 110 of the group 102 connected with the shared digital fund 112.

In some examples, the contactless payment instrument 124 may be issued to one or more digital wallets associated with the one or more users 104 of the group 102 connected with the shared digital fund 112. That is, the contactless payment instrument 124 may be used outside of the digital fund application 304 via a digital wallet associated with one or more users 104.

In the example of FIG. 5, the user 104 may utilize a mobile device 116 loaded with the contactless payment instrument 124 to attempt a transaction with a business. In particular, the user may indicate via the payment terminal 504 and/or indicate to an attendant 502 at the business establishment that they would like to process a transaction using the contactless payment instrument 124 to pay for certain goods and/or services.

In some examples, the mobile device 116 can be configured to send and/or receive wireless data, e.g., data relating to a transaction and/or user authentication data. That is, according to the present disclosure, the mobile device 116 may establish a contactless connection with the payment terminal 504, where the contactless connection utilizes at least one of Wi-Fi, Bluetooth, and Near Field Communication (NFC).

Once the payment terminal 504 receives the payment information of the contactless payment instrument 124 from the mobile device 116, a transaction amount is debited from the contactless payment instrument 124 by the business's financial institution 506 (e.g., bank, etc.). In the example of FIG. 5, the business's payment processor 506 may then process the transaction with a payment processor 508 that actually holds the funds corresponding to the contactless payment instrument 124.

In some examples, the payment processor 508 may be in communication with the remote server 106 over a communication network and may report the details of the transaction instance to the digital fund database 108. In particular, transaction information 510 may be generated in connection with the one or more transactions like those described herein. This transaction information 510 may include, but is not limited to, a transaction ID number specific to each transaction, an identification of the contactless payment instrument 124 used in each transaction, metadata containing date, time, location, authentication data, and/or the like associated with each transaction, one or more transaction numbers that are unique to the payment processors 506, 508, and the like.

As such, the transaction information 510 may be received by the remote server 106 and used to update the digital ledger 114. That is, the transaction information 510 can be received by the remote server 106 and used to update the account information associated with one or more participant accounts 110. In some examples, updating the digital ledger 114 with transaction information 510 for one or more transaction instances provides a real-time snapshot of the transactions associated with each shared digital fund 112 and a real-time balance amount in each shared digital fund 112. According to further examples, each user 104 associated with a participant account 110 that is connected to a shared digital fund 112 may utilize the digital fund application 304 (e.g., via a mobile device 116) to view these transactions and balances in real-time.

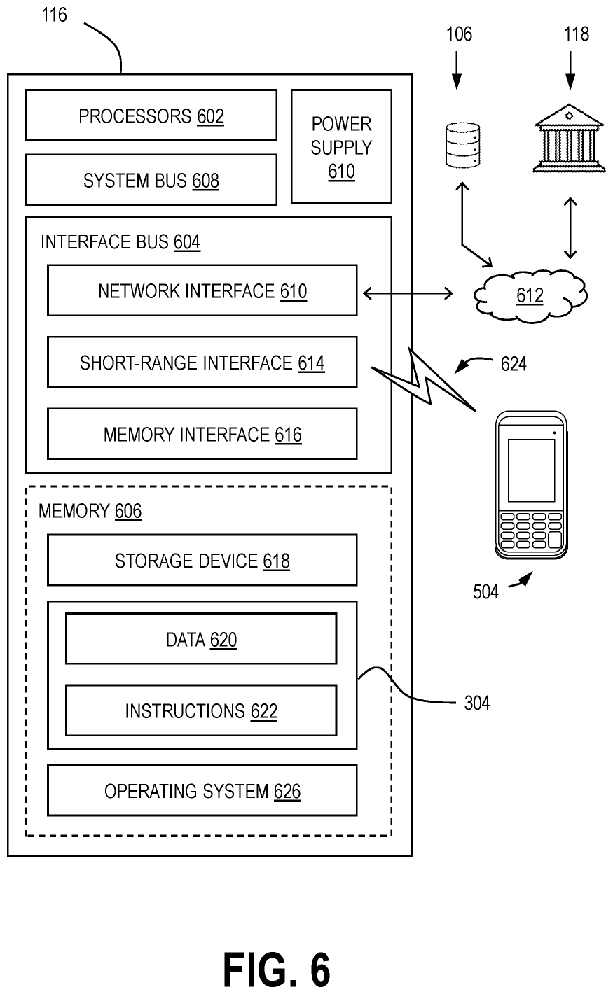

FIG. 6 illustrates one example of a mobile device 116 configured as such. In the example of FIG. 6, the mobile device 116 includes one or more processors 602, an interface bus 604, and a memory 606, all of which may be interconnected and/or communicate through a system bus 608 containing conductive circuit pathways through which instructions (e.g., machine-readable signals) may travel to effectuate communication, tasks, storage, and the like. The mobile device 116 may be connected to a power source 610, which can include an internal power supply and/or an external power supply.

The one or more processors 602 may include a high-speed data processor adequate to execute the program components described herein and/or various specialized processing units as may be known in the art. In some examples, the one or more processors 602 may be a single processor, multiple processors, or multiple processor cores on a single die.

In some examples, the interface bus 604 may include a network interface 612 configured to connect the mobile device 116 to a communications network 612, a short-range interface 614 configured to wirelessly transmit and/or receive information with devices (e.g., payment terminal 504) within short ranges from the mobile device 116, and/or a memory interface 616 configured to accept, communicate, and/or otherwise connect the mobile device 116 to a number of machine-readable memory devices (e.g., memory 606).

The network interface 610 may operatively connect the mobile device 116 to a communication network 612, which can include a direct interconnection (i.e., wired), the Internet, a local area network (LAN), a metropolitan area network (MAN), a wide area network (WAN), a wired or Ethernet connection, a wireless connection, and similar types of communications networks, including combinations thereof. In some examples, the mobile device 116 may transmit and/or receive information via the communication network 612 to and/or from one or more remote servers 106. In further examples, the mobile device 116 may transmit and/or receive information via the communication network 612 to and/or from one or more payment processors 118.

The short-range interface 614 may operatively connect the mobile device 116 with one or more external devices (e.g., payment terminal 504) within short ranges from the mobile device 116. That is, the mobile device 116 may establish a contactless connection 624 with the payment terminal 504, where the contactless connection utilizes at least one of Wi-Fi, Bluetooth, and Near Field Communication (NFC). In specific examples, the short-range interface 614 includes one or more modules and/or transceivers configured to communicate over short-range protocols, such as Bluetooth and/or NFC (e.g., ECMA-340 and ISO/IEC 18092, etc.).

The memory 606 can be variously embodied in one or more forms of machine-accessible and machine-readable memory. In some examples, the memory 606 may include a storage device 618 that comprises one or more types of memory. For example, the storage device 618 can include, but is not limited to, a non-transitory storage medium, a magnetic disk storage, an optical disk storage, an array of storage devices, a solid-state memory device, and the like, including combinations thereof.

Generally, the memory 606 is configured to store data/information 620 and/or instructions 622 that, when executed by the one or more processors 602, causes the mobile device to perform one or more tasks. In particular examples, the memory 606 may include a digital fund application 304 that comprises a collection of program components, database components, and/or data. Depending on the particular implementation, the digital fund application 304 may include software components, hardware components, and/or some combination of both hardware and software components.

According to the present disclosure, the digital fund application 304 may include, but is not limited to, instructions 622 that control/operate the display screen of the mobile device 116 and/or perform one or more of the functions described with respect to FIGS. 1-7.

That is, in particular examples, the mobile device 116 comprises a digital fund application 304 that, when executed by the one or more processors 602, performs one or more of the following: transmit, via the communication network 612, one or more requests to a remote server 106; receive, via the communication network 612, one or more contactless payment instruments 124 from the remote server 106, wherein each contactless payment instrument 124 comprises payment information associated with one or more digital funds 112; transmit, via a contactless connection 624, payment information of at least one of the received contactless payment instruments 124 to a payment terminal 504, wherein transmitting the payment information to the payment terminal initiates a transaction instance; receive, via the communication network 612, account information corresponding to at least one participant account from the digital fund database 108 of the remote server 106; display, on a display screen of the mobile device 116, at least the payment information corresponding to the one or more received contactless payment instruments 124; and/or receive, via the communication network 612, digital fund information from the digital fund database 108 of the remote server 106, wherein the digital fund information includes one or more restrictions on the use of a digital fund 112 associated with the user 104.

In some examples, the one or more digital fund restrictions can include a location-based restriction, a merchant-based restriction, and/or a time-based restriction. For instance, a location-based restriction may limit the ability of a user 104 to use a contactless payment instrument 124 to access a shared digital fund 112 unless the transaction is occurring in a predefined location (e.g., a contactless payment instrument 124 may only be used within a particular country, or within a particular city, for example, according to a location-based restriction). However, it should be appreciated that other types of location-based restrictions may be employed.

In another instance, a merchant-based restriction may limit the ability of a user 104 to use a contactless payment instrument 124 to access a shared digital fund 112 unless the transaction is occurring in at a predefined merchant or type of merchant (e.g., a contactless payment instrument 124 may only be used at grocery stores and restaurants, or only at transportation companies, according to a merchant-based restriction). However, it should be appreciated that other types of merchant-based restrictions may be employed.

In yet another instance, a time-based restriction may limit the ability of a user 104 to use a contactless payment instrument 124 to access a shared digital fund 112 unless the transaction is occurring within a predefined period of time (e.g., the contactless payment instrument 124 may only be used on the first weekend of every month, or during a particular week, according to a time-based restriction). According to another example, the time-based restriction is a predetermined time limit during which the digital fund can be utilized with the contactless payment instrument to make a payment. For example, when the digital fund is created for funded, the creation or funding request may comprise a time limit parameter, or the system may automatically implement a predetermined time limit. For example, the users may decide that the digital fund is for expenses during a particular time period such as an evening, a holiday, or other time period. When that time period has ended, the predetermined time limit is up and. As described elsewhere herein, once the predetermined time limit has ended, the contactless payment instrument is suspended, terminated, or inactivated, and any funds remaining in the digital fund are evenly redistributed to the users. It should be appreciated that other types of time-based restrictions may be employed.

As shown in the example of FIG. 6, the mobile device 116 may further include an operating system component 626, which may be stored in the memory 606. The operating system component 626 may be an executable program facilitating the operation of the mobile device 116, including but not limited to, operation of the digital fund application 304. Typically, the operating system component 626 can facilitate access of the interface bus 604 and can communicate with other components of mobile device 116 (e.g., user input device, display screen, etc.).

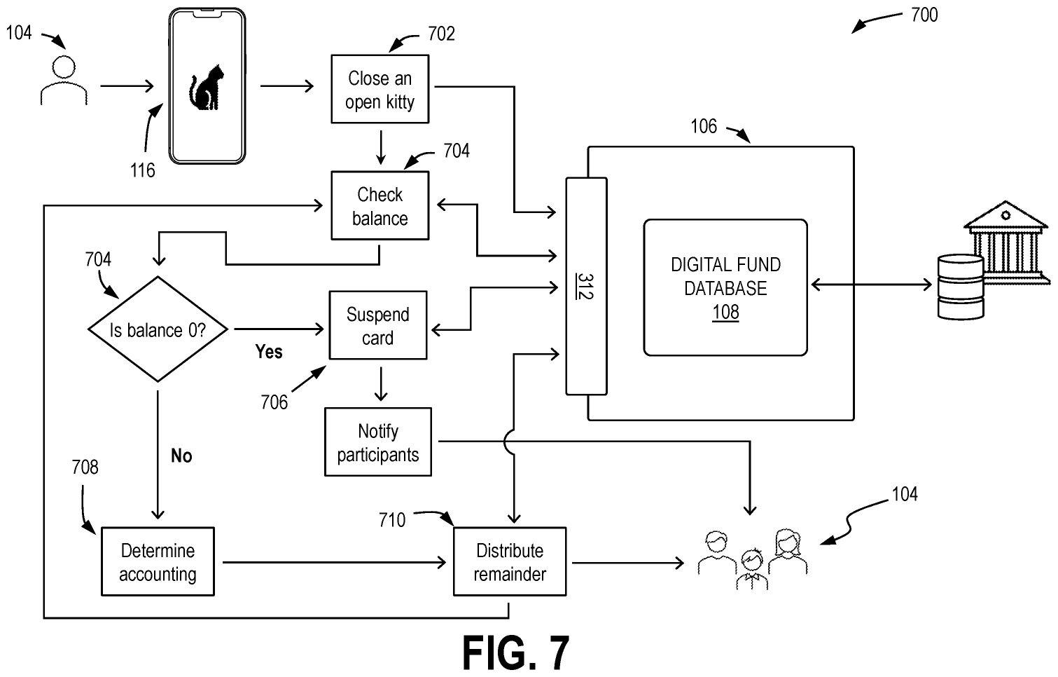

FIG. 7 illustrates a flow diagram of a process 700 for closing (i.e., de-activating) a shared digital fund 112 according to certain aspects of the present disclosure. In the example of FIG. 7, the process 700 of closing a shared digital fund 112 may begin with a user 104 transmitting a request 702 to close a shared digital fund 112 to the remote server 106. In some examples, the request 702 can be transmitted from a mobile device 116 operating a digital fund application 304 associated with a participant account 110. In further examples, the participant account 110 making the request 702 is connected with the shared digital fund 112 to be closed and/or is otherwise authorized to close the particular shared digital fund 112.

Upon receiving the request 702, the remote server 106 may query 704 the digital fund database 108. At a step 704, the remote server 106 then determines whether the shared digital fund 112 to be closed contains any remaining balance. If the balance of the shared digital fund 112 is zero, then the any contactless payment instruments 124 generated in connection with the shared digital fund 112 is suspended (i.e., can no longer be used by the users 104) at a step 706. Otherwise, at a step 708, the remote server 106 may determine an accounting of the funds remaining in the shared digital fund 112. In some examples, the accounting of the funds remaining in the shared digital fund 112 includes determining a refund amount for each of the participant accounts 110 connected with the shared digital fund 112 to be closed. Then, in a step 710, the remote server 106 may distribute the remaining funds to the one or more participants 104 according to the determine accounting of the funds.

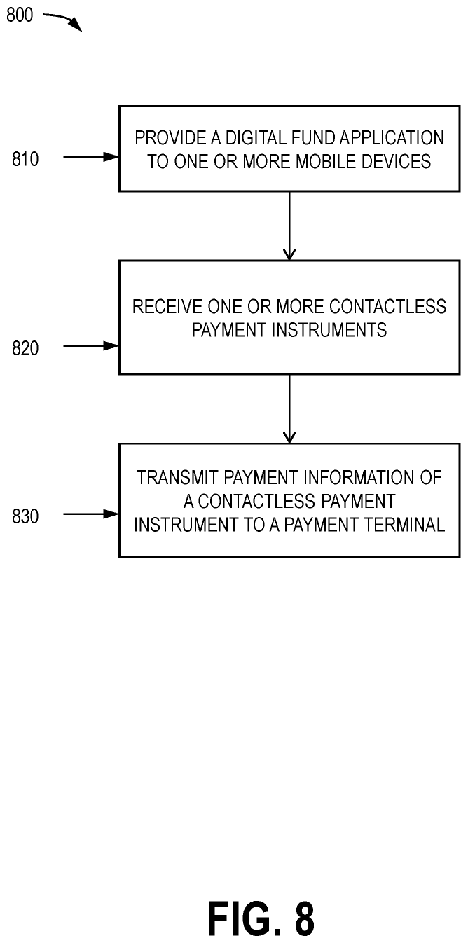

FIG. 8 illustrates a flowchart of a method 800 of distributing one or more contactless payment instruments 124 over a communication network 612 to one or more mobile devices 116 according to certain aspects of the present disclosure. In the example of FIG. 8, the method 800 includes, in a step 810, providing a digital fund application 304 to one or more mobile devices 116. In some examples, each mobile device 116 may include a processor configured to transmit, via the communication network 612, one or more requests to a remote server 106 that supports a digital fund database 108, and to receive, via the communication network 612, one or more contactless payment instruments 124 from the remote server 106.

In a step 820, the method 800 may include receiving, at one or more mobile devices 116, one or more contactless payment instruments 124 generated by the remote server 106 in connection with one or more digital funds 112. In some examples, multiple contactless payment instrument 124 connected with the same digital fund 112 may be shared with multiple mobile devices 116.

In a step 830, the method 800 may include transmitting, via a contactless connection 624, the payment information of at least one of the received contactless payment instruments 124 to a payment terminal 504. According to the present disclosure, transmitting the payment information of the contactless payment instrument 124 to a payment terminal 504 initiates a transaction instance. That is, presenting the contactless payment instrument 124 to the payment terminal 504 triggers one or more payment processors 118 to process a transaction as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A system supporting a payment network of digital funds, comprising:
a digital fund database comprising:
a plurality of participant accounts, each participant account being associated with at least one user and comprising a digital payment source; and
a digital fund, the digital fund being connected to each of the plurality of participant accounts and being accessible via a contactless payment instrument; and
a remote server in communication with one or more payment processors and a plurality of mobile devices, each of the plurality of mobile devices being associated with one of the plurality of participant accounts and the respective at least one user, wherein the remote server comprises or is in communication with the digital fund database and is configured to:
receive a request from at least one of the plurality of mobile devices via a digital fund application being executed on the plurality of mobile devices, the request comprising a request to create and/or fund the digital fund by the plurality of participant accounts;
process, for each of the plurality of participant accounts via the one or more payment processors, a transaction adding a currency amount to the digital fund from the one or more digital payment sources to create a funded digital fund, wherein each of the plurality of participant accounts contributes an equal currency amount to the digital fund;
generate, via the one or more payment processors, a contactless payment instrument connected with the funded digital fund, each contactless payment instrument comprising payment information, wherein each of the plurality of participant accounts are enabled to access the contactless payment instrument; and
update each of the plurality of participant accounts with the payment information for the contactless payment instrument.

2. The system of claim 1, wherein the remote server is further configured to receive, from one or more payment processors, transaction information for a transaction instance corresponding to a transaction using the contactless payment instrument.

3. The system of claim 1, wherein the digital fund database further comprises a digital ledger comprising a record of each transaction instance associated with the digital fund, and wherein the remote server is configured to update the digital ledger upon receiving the transaction information.

4. The system of claim 1, wherein the funded digital fund comprises a predetermined time limit, wherein upon reaching the predetermined time limit the remote server suspends the contactless payment instrument and refunds, using the one or more payment processors, any currency amount remaining in the funded digital fund split evenly to the plurality of participant accounts.

5. The system of claim 1, wherein upon receiving a closing request from any one of the plurality of participants, the remote server suspends the contactless payment instrument and refunds, using the one or more payment processors, any currency amount remaining in the funded digital fund split evenly to the plurality of participant accounts.

6. The system of claim 1, wherein the remote server is configured to generate the contactless payment instrument connected with the digital fund upon receiving a request from one of the plurality of mobile devices.

7. The system of claim 1, wherein the one or more digital payment sources includes at least one of: a bank account, a credit card, a debit card, an online payment account, and a digital wallet.

8. The system of claim 1, wherein the remote server is further configured to:
receive, from one of the plurality of mobile devices, user information comprising user credentials, wherein the user information corresponds to the participant account associated with the mobile device;
validate the received user credentials in connection with the participant account from the digital fund database; and
upon validation of the user credentials, transmit participant account information to the mobile device.

9. A mobile device associated with a digital payment network, the mobile device comprising a processor and a digital fund application configured to cause the mobile device to:
transmit a request to create and/or fund a digital fund of the digital payment network by a plurality of participant accounts including the participant account associated with the mobile device, the digital fund being connected to each of the plurality of participant accounts and being accessible via a contactless payment instrument;
receive information from the digital payment network comprising confirmation that the digital fund has been funded by the plurality of participant accounts, wherein each of the plurality of participant accounts funds an equal portion of the digital fund, and wherein the received information further comprises a contactless payment instrument connected with the funded digital fund, the contactless payment instrument comprising payment information, wherein each of the plurality of participant accounts are enabled to access the contactless payment instrument; and
make a transaction using the contactless payment instrument.

10. The mobile device of claim 9, wherein the digital fund comprises a predetermined time limit, wherein upon reaching the predetermined time limit the contactless payment instrument is suspended, and wherein the processor and the digital fund application are further configured to cause the mobile device to:
receive information from the digital payment network comprising a refund, split evenly amount the plurality of participant accounts, of any currency amount remaining in the funded digital fund upon reaching the predetermined time limit.

11. The mobile device of claim 9, wherein the processor and the digital fund application are further configured to cause the mobile device to:
transmit a closing request to the digital payment network; and
receive information from the digital payment network comprising a refund, split evenly amount the plurality of participant accounts, of any currency amount remaining in the funded digital fund upon receiving the closing request.

12. The mobile device of claim 9, wherein the processor and the digital fund application are further configured to cause the mobile device to:
transmit user information comprising user credentials to the digital payment network, wherein the user information corresponds to the participant account associated with the mobile device; and
receive participant account information from the digital payment network once the transmitted user credentials are validated.

13. The mobile device of claim 9, wherein the processor and the digital fund application are further configured to cause the mobile device to:
receive, from the digital payment network, one or more of transaction information for one or more transaction instances associated with the digital fund, and a real-time balance amount of the digital fund.

14. The mobile device of claim 9, wherein the processor and the digital fund application are further configured to cause the mobile device to:
display, on a display screen, one or more of information about the digital fund, and payment information or transaction information corresponding to the contactless payment instrument.

15. The mobile device of claim 9, wherein the digital fund comprises a digital fund restriction, the digital fund restriction comprising one or more of a location-based restriction, a merchant-based restriction, and a time-based restriction.

16. The mobile device of claim 9, wherein the processor and the digital fund application are further configured to cause the mobile device to:
transmit payment information of the contactless payment instruments to a payment terminal, wherein transmitting the payment information to the payment terminal initiates a transaction instance.

17. A method of generating a contactless payment instrument funded by a digital fund of a digital payment network, comprising the steps of:
receiving, from a mobile device executing a digital fund application, a request to fund a digital fund of the digital payment network, wherein the digital fund is funded by a plurality of participant accounts including a participant account associated with the mobile device, the digital fund being connected to each of the plurality of participant accounts;
processing, for each of the plurality of participant accounts via one or more payment processors, a transaction adding a currency amount to the digital fund, wherein each of the plurality of participant accounts contributes an equal currency amount to the digital fund;
generating, via the one or more payment processors, a contactless payment instrument connected with the digital fund, each contactless payment instrument comprising payment information, wherein each of the plurality of participant accounts are enabled to access the contactless payment instrument; and
updating each of the plurality of participant accounts with the payment information for the contactless payment instrument.

18. The method of claim 17, wherein the digital fund comprises a predetermined time limit, and wherein the method further comprises:
suspending or terminating the contactless payment instrument when the predetermined time limit is reached; and
refunding, using the one or more payment processors, any currency amount remaining in the digital fund split evenly among the plurality of participant accounts.

19. The method of claim 17, further comprising:
receiving a closing request from any one of the plurality of participants;
suspending or terminating the contactless payment instrument in response to the received closing request; and
refunding, using the one or more payment processors in response to the received closing request, any currency amount remaining in the digital fund split evenly among the plurality of participant accounts.

20. The method of claim 17, further comprising:
receiving, from a mobile device associated with one of the plurality of participant accounts, transaction information for a transaction instance corresponding to a transaction using the contactless payment instrument.
